(19) United States
(12) Patent Application Publication
(10) Pub. No.: US 2005/0092137 A1
(43) Pub. Date: May 5, 2005

(54) Socket and method for making the same

(76) Inventor: Yao-Lin Cho, Da-An Township (TW)

Correspondence Address: Mr. Phillip Liu, 6980 Whiteoak Dr., Richmond, BC, V7E 4Z9, CA

(21) Appl. No.: 10/699,843

(22) Filed: Nov. 4, 2003

(51) Int. Cl. B25B 13/06

(52) U.S. Cl. 81/121.1

(57) ABSTRACT

A socket includes tubular body which has a polygonal protrusion integrally formed on an end of the tubular body by way of forging and a polygonal engaging hole is defined in an end of the protrusion. A polygonal recess is defined in the other end of the tubular body so as to mount onto a nut or the like.

### FIELD OF THE INVENTION

The present invention relates to a socket that has a polygonal recess in one end and a polygonal protrusion extending from the other end of the socket and an engaging hole is defined in the polygonal protrusion.

### BACKGROUND OF THE INVENTION

A conventional socket 30 for driving a nut is shown in FIG. 4 and generally includes a tubular body and a polygonal recess 300 defined in one end thereof and an engaging hole 31 is defined in the other end of the socket 30 such that a ratchet tool 40 is connected to the socket 30 by inserting an engaging rod 41 of the tool in the engaging hole 31. Nevertheless, this type of sockets can only be used with specific type of tool and this cannot be satisfied by the users. FIG. 5 shows another type of conventional socket 30′ which has a polygonal protrusion 300′ extending from an end of the socket 30′ such that a box end of a wrench can be mounted to the polygonal protrusion 300′ and rotates the socket 30′. The polygonal protrusion 300′ is made by a milling process which takes a lot of time. Besides, during milling, high temperature causes the material of the polygonal protrusion to be less strong.

The present invention intends to provide a socket that is made by way of forging and includes a polygonal protrusion so as to meet the requirement of strength and functions from the users.

### SUMMARY OF THE INVENTION

The present invention relates to a socket which comprises a tubular body having a polygonal recess defined in a first end thereof and a polygonal protrusion extends from a second end of the tubular body with a polygonal engaging hole defined in the polygonal protrusion.

The socket is made by the following steps:
step 1: preparing a tubular body and drilling a positioning recess in a first end of the tubular body; step 2: drilling a polygonal recess defined in a second end of the tubular body; step 3: forging a periphery of the first end of the tubular body into a polygonal protrusion; and step 4: drilling a polygonal engaging hole in an end of the polygonal protrusion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1-1 shows a tubular body is prepared;

FIG. 1-2 shows a positioning recess is defined in an end of the tubular body;

FIG. 1-3 shows a polygonal recess is defined in an end of the tubular body;

FIG. 1-4 shows a polygonal protrusion is forged at the other end of the tubular body;

FIG. 1-5 is an end view to show the polygonal protrusion;

FIG. 2-1 shows a polygonal hole is defined in an end of the polygonal protrusion;

FIG. 2-2 is an end view to show the polygonal recess defined in the tubular body;

FIG. 2-3 shows the sizes of the polygonal engaging hole, the polygonal recess of the socket;

FIG. 3 is a perspective view to show the socket of the present invention;

FIG. 4 shows a conventional socket and a ratchet tool, and

FIG. 5 shows another conventional socket and a wrench.

### DETAILED DESCRIPTION OF THE PREFERRED EMBODIMENT

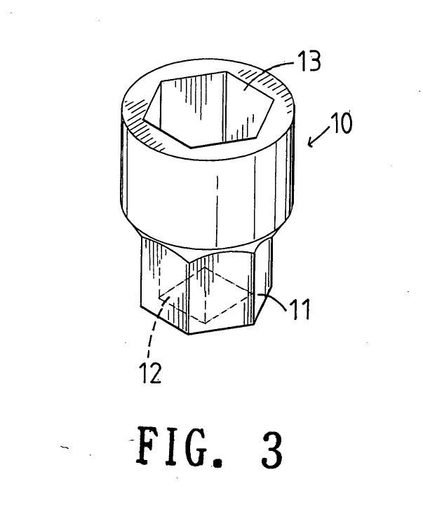

Referring to FIG. 3, the socket 10 of the present invention comprises a tubular body having a polygonal recess 13 defined in a first end thereof and a polygonal protrusion 11 extends from a second end of the tubular body. A polygonal engaging hole 12 is defined in the polygonal protrusion 11. The polygonal recess 13 is used to mount onto a nut or the like and the engaging hole 12 is to be connected with an engaging rod of a ratchet tool.

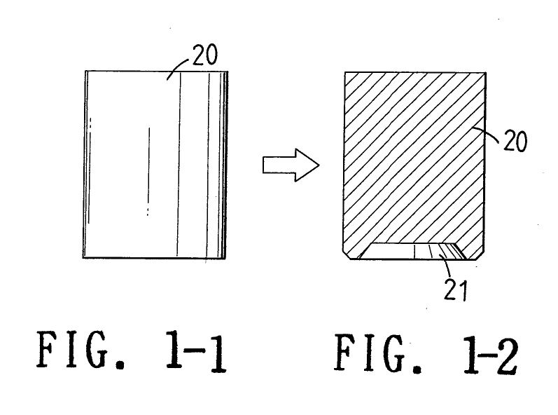

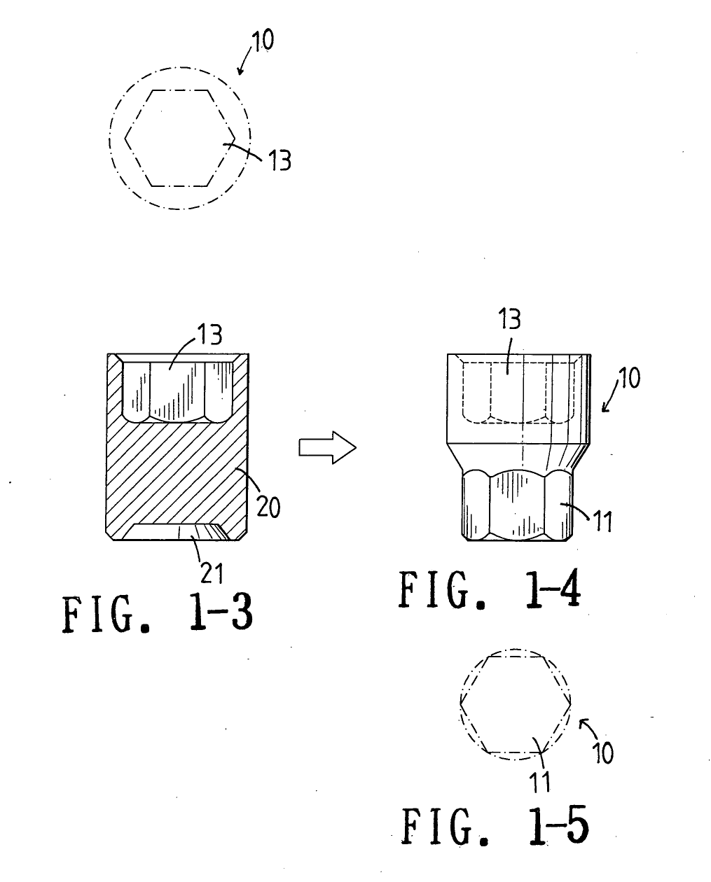

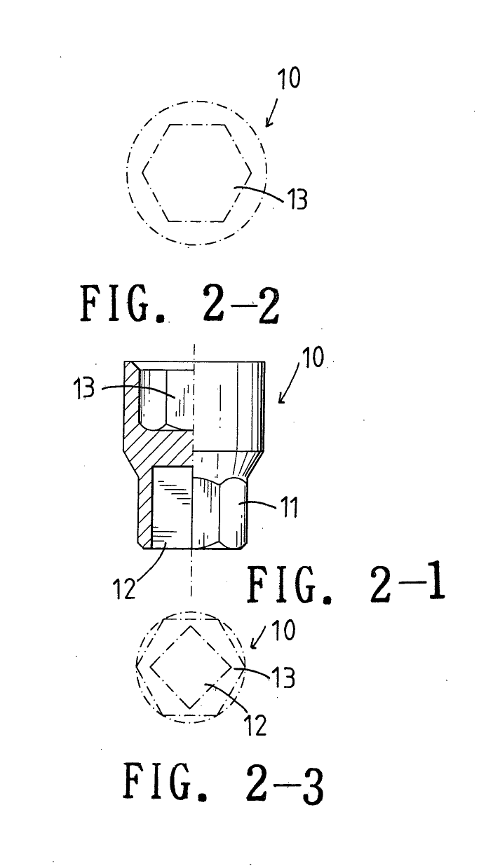

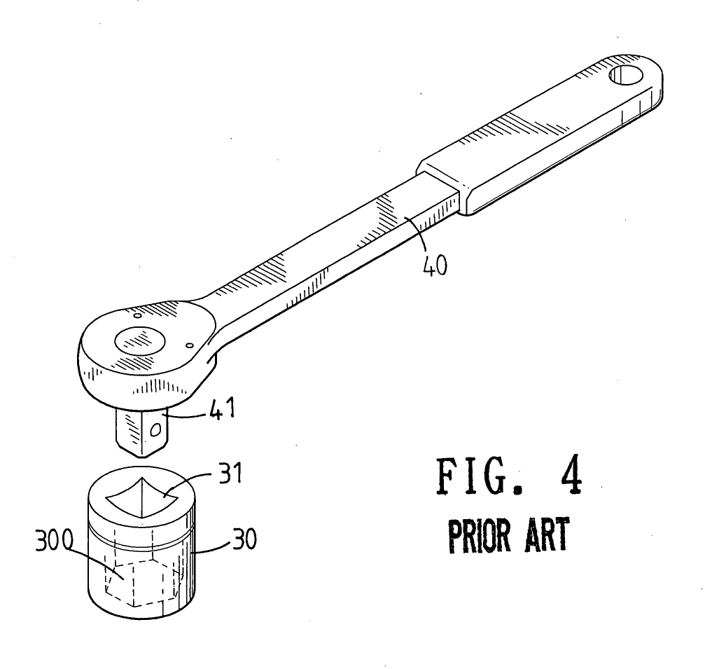

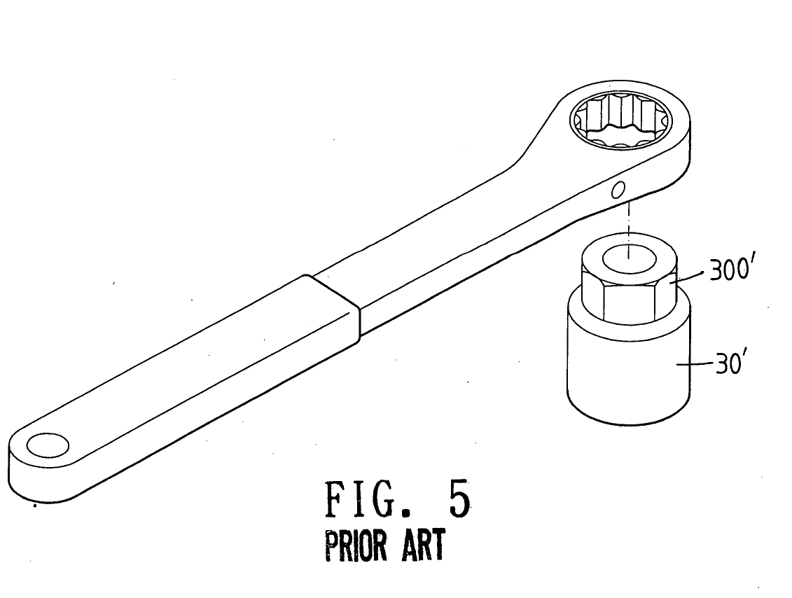

The method for making the socket includes the following steps:
step 1: preparing a tubular body 20 and drilling a positioning recess 21 in a first end of the tubular body 20 as shown in FIGS. 1-1 and 1-2;
step 2: drilling a polygonal recess 13 defined in a second end of the tubular body 20 as shown in FIGS. 1-3 and 2-2;
step 3: forging a periphery of the first end of the tubular body 20 into a polygonal protrusion 11 as shown in FIGS. 1-4 and 1-5;
step 4: drilling a polygonal engaging hole 12 in an end of the polygonal protrusion 11 as shown in FIGS. 2-1 and 2-3.

The socket 10 can be rotated by an open end of box end of a wrench at the polygonal protrusion 11, and a ratchet tool can also be drive the socket 10 by inserting its engaging rod in the polygonal engaging hole 12. Furthermore, the polygonal protrusion 11 is made by forging so that the strength of the socket is strong enough.

While we have shown and described the embodiment in accordance with the present invention, it should be clear to those skilled in the art that further embodiments may be made without departing from the scope of the present invention.

1. (canceled).

2. A method for making a socket which includes a tubular body having a polygonal recess defined in a first end thereof and a polygonal protrusion extending from a second end of the tubular body, a polygonal engaging hole defined in the polygonal protrusion, the method comprising:
step 1: preparing a tubular body and drilling a positioning recess in a first end of the tubular body;
step 2: forging a polygonal recess defined in a second end of the tubular body;
step 3: forging a periphery of the first end of the tubular body into a polygonal protrusion; and
step 4: forging a polygonal engaging hole in the positioning recess in an end of the polygonal protrusion.
